(19) United States
(12) Patent Application Publication
(10) Pub. No.: US 2010/0012409 A1
(43) Pub. Date: Jan. 21, 2010

(54) DRIVE MODULES FOR VEHICLES

(76) Inventors: DAVID C. HEIDENREICH, Akron, OH (US); Steven A. Caskey, North Lawrence, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 12/363,981

(22) Filed: Feb. 2, 2009

Related U.S. Application Data
(63) Continuation-in-part of application No. 12/218,593, filed on Jul. 17, 2008.

(51) Int. Cl. B60W 10/08; H02K 9/19; H02K 7/116; F16H 63/08; B60W 20/00

(52) U.S. Cl. 180/65.265; 310/54; 310/83; 74/473.11; 903/909

(57) ABSTRACT

An oil cooled electric drive module for hybrid vehicles includes an AC motor assembly having a shaft parallel to an output shaft, with the shafts being interconnected by a set of helical reduction gears. The motor shaft is provided with a rotary union for cooling oil that passes first axially and then radially through the shaft to an outer circumferential surface thereof beneath the core of a rotor attached thereto. The cooling oil passes beneath the rotor to the outer ends thereof, where annular deflectors disburse the oil to provide a coanda effect over the shorting rings of the rotor, onto the stator windings, and thence onto the motor housing for return to a cooling sump, which may include hydraulic and electric pumps for further desired cooling circulation. The invention also includes solenoid valves for shifting a splined collar between positions of interconnection and disconnection between the motor shaft and output shaft. The module of the invention is adapted for interpositioning within the drive shaft of a motor vehicle, with the output shaft of the module being connected at opposite ends to the vehicle drive shaft. The module is employed in various drive systems employing segmented shafts and multiple gear ratio clutch and gear assemblies. The clutch assemblies are of the dog type, and are spring loaded with a neutral position, hydraulic cushioning and synchronized control. The clutch assemblies operate for various interconnections between the various segments of a drive shaft and the shafts of one or more motor/generators.

### CROSS REFERENCE TO RELATED APPLICATION

This is a continuation-in-part of copending application Ser. No. 12/218,593, filed Jul. 17, 2008, for Oil Cooled Electric Drive Module for Hybrid Vehicles.

### TECHNICAL FIELD

The invention herein resides in the art of hybrid vehicles, particularly of the type adapted for implementation of alternate drive sources. Particularly, the invention relates to a module including an electric drive motor adapted for selective interconnection with the drive shaft of a vehicle to alternatingly provide an electric motor or heat engine as the power source for the vehicle drive mechanism. Specifically the invention relates to a post transmission hybrid drive module having parallel motor and output shafts, the output shaft being interconnected with the drive shaft of a vehicle and the motor shaft being selectively engageable with the output shaft.

The invention further relates to uniquely configured and optimally controlled series/parallel hybrid drive modules for vehicles that allow for ease of shifting between power sources and outputs, consistent with maximizing the efficiency of the operation of the vehicle. Specifically, the invention relates to a series/parallel hybrid drive module for vehicles, uniquely adapted for implementation with heat engines and motor generator assemblies, and having a unique segmented input/output shaft with associated gears and shift mechanisms to ensure smooth and effective operation between various input sources and output loads. The invention is adapted for implementation with commercial, military, construction and agricultural equipment, and particularly relates to vehicles of all types, including electric, fuel cell, and hybrid vehicles having significant electrical energy storage that can operate for extended periods on electricity alone.

### BACKGROUND OF THE INVENTION

The cost of fuel for the engines typically employed for driving vehicles has given rise to an acute need for alternative fuels or hybrid vehicles, adapted for implementation of various fuel sources. Presently, the most advantageous type of an alternate fuel vehicle is the hybrid vehicle, which, in its most common sense, employs a diesel or gas powered engine and an electric motor as alternative power sources. Prior attempts to achieve this combination have generally met with disappointment, being either excessively costly or under powered in providing motive force. Moreover, the packaging of alternative power sources has been given to complexities that have yet to be overcome, resulting in vehicles that are not only costly, but given to service and maintenance problems. Moreover, presently known electric motors and their methods of implementation have been fraught with power output that is inconsistent with the bulk, size, weight and cost of the motor being implemented.

The instant invention provides a module for use with electric vehicles, hybrid electric vehicles, plug-in hybrid electric vehicles and other applications requiring high performance, light weight, and economical electric motors and/or generators. It is known that the alternating current (AC) induction motor is the simplest and least expensive type of electric motor for vehicle traction drives. The advent of Flux Vector inverter drive controls provides for variable frequency control up to very high speeds for standard induction motors. Standard motors are typically wound for the common 60 hertz frequency that is used in the United States, or 50 hertz, which is used for the most part in the remainder of the world. High frequency motor invertor drives can operate into the range of 200 to 400 hertz, resulting in motor speeds up to 12,000 rpm for common four pole motors that normally run at 1,800 rpm. A properly matched controller and high speed motor can produce 3 to 5 times the peak power from a similarly sized standard AC induction motor. Further, with effective cooling such a motor can produce 5-10 times the continuous power rating of a standard fan cooled motor and even well beyond that of water jacket cooled motors. Particularly problematic is the need for removal of the heat in the rotor core and stator windings to achieve high continuous power.

It is well known that an AC induction motor commonly uses a “squirrel cage” rotor as its only rotating part. In overall shape, the rotor is a cylinder mounted on a shaft. Internally, it contains axial or longitudinal conductive bars of aluminum or copper set in grooves or holes in the rotor laminations and connected at both ends by shorting rings of aluminum or copper to form a cage-like conductive structure. The core of the rotor is built up of a stack of iron laminations. The field winding in the stator of an induction motor sets up a rotating magnetic field around the rotor. The relative motion between this field and the rotation of the rotor induces electric current flow in the conductive bars. In turn, these currents flowing lengthwise in the conductors react with the magnetic field of the motor stator windings to produce a force acting at a tangent to the rotor, resulting in torque to turn the motor shaft. In effect, the rotor is carried around with a magnetic field, but at a slightly slower rate of rotation. The difference in speed is called “slip” and increases with load.

Motor vehicles employing hybrid drive systems to drive the vehicle are well known in the art. Typically, the hybrid power train system is either a series or parallel hybrid configuration. In general, a series hybrid configuration includes a heat engine, an electric generator, an electricity energy storage and management system, a traction electric motor, and final drive unit, all functionally connected in series to move the vehicle without direct mechanical connection. The series hybrid configuration is more efficient for urban driving, but suffers from the disadvantage of being less efficient for highway driving, in that it has the inherent losses in the motor/generator that is less efficient than a highly efficient “manual” or automated manual transmission.

Typically, a parallel hybrid configuration includes a heat engine, one or more electric generators that also function as traction motors, a transmission with electric motor/generators either before or after (pre or post) the transmission, an electricity energy storage and management system, and a final drive unit. These components are managed such that there exists functionally parallel and independent paths from the heat engine and the propulsion motor to move the vehicles. The parallel hybrid configuration is more efficient for highway driving and many specialty vehicle needs, such as acceleration, deceleration, and hill climbing, to name a few. However, the parallel hybrid tends to suffer a disadvantage of being less efficient for urban driving.

There are various configurations of hybrid drives that combine electric motors in planetary transmission arrangements. Such drives combine series and parallel capabilities using planetary gearing, but suffer from electric motors that must operate at slower speeds that hinder their maximum power capability. Further, these configurations generally utilize multiple disk friction clutches that detract from the overall transmission efficiency when one or more of these clutches are disengaged. Multiple disk wet clutches, such as used in automatic transmissions, are very inefficient when they are idling due to the fluid dynamic drag torque inherent in the disks with oil flowing through them. Thus, there is a trend toward “dual clutch” transmissions where only friction clutches provide alternating smooth shifting in an automated manual transmission. But, even these are less efficient than a “manual” transmission. In addition, planetary geared series/parallel hybrids require very expensive tooling in high production quantities, which can preclude their general use in lower volume commercial, construction, and military vehicles.

There is a need in the art for a simple, cost effective and reliable series/parallel hybrid drive module for vehicles that allows for optimization of use of various power sources, including by way of example but not limitation, heat engines and electric motors. It is particularly desirable that shift and select mechanisms are provided in association with the power train to ensure optimum selectability between various power sources and output loads, allowing the vehicle to operate efficiently at highway speeds, slow urban speeds, when negotiating hills, when operating at idle or in “hotel” mode, or when simply operating as a generator for exportable electric power, or to restore the battery power source for electric operation.

### SUMMARY OF INVENTION

In light of the foregoing, it is a first aspect of the invention to provide a new and improved hybrid power train system for vehicles with heat engines, which employs features of both series and parallel hybrid configurations.

Another aspect of the invention is the provision for a drive system that can operate in either series or parallel hybrid configurations.

Still a further aspect of the intention is to provide a drive system that can utilize the engine and both an input side and output side hybrid motor in parallel with the engine for maximum power needs of the vehicle.

Still a further aspect of the invention is the provision of a drive system that allows significant downsizing of the vehicle engine to maximize fuel economy.

Another aspect of the invention is the provision of a drive system employing an oil cooled electric drive module or modules that can significantly reduce the weight and cost of electric motors for vehicle traction drives.

An additional aspect of the invention is the provision of a drive system that accommodates powering various accessory systems of a motor vehicle from the hybrid power train system.

Yet another aspect of the invention is the provision of a drive system that includes the ability to export power from either one or both of a pair of motor generators and an associated energy storage system, while the vehicle is stationary.

A further aspect of the invention is to provide a drive system that may allow the engine to recharge the battery when the vehicle is stationary.

Another aspect of the invention is to provide a drive system that accommodates packaging of the motor-generator and related gearing, clutches and actuators in the area normally used for a conventional transmission in the vehicle.

It is still a further aspect of the invention to provide a drive system having a sufficient number of automatically shifted manual gear sets to allow the engine to aid in vehicle acceleration, and to efficiently provide the sole means of the vehicle propulsion for all speeds above a given threshold.

An additional aspect of the invention is the provision of a vehicle drive system that eliminates the inefficiency of idling multiple disk wet friction clutches from the drive system, particularly when the engine is operating.

Another aspect of the invention is to provide a hybrid power train drive system that employs automated rapid shifting of the manual gear changes to minimize power interruption during shifting.

An additional aspect of the invention is the provision of a hybrid power train drive system having multiple electric motors, and in which at least one of the electric motors can always be engaged to the driven wheels during gear shifting.

Another aspect of the invention is the provision of a hybrid power train drive system in which an electric motor that is driving during shifting provides a maximized torque momentarily to maintain smooth acceleration during shifting.

Still a further aspect of the invention is the provision of an improved hybrid power train system that allows for acceptable vehicle operation even in the absence of operation of electric motors/generators.

Still another aspect of the invention is to provide an improved power train system that may be used in battery powered electric vehicles or fuel cell powered vehicles having the foregoing advantages, but without the need of a heat engine, and provide improved drive system efficiency with zero emissions.

Yet a further aspect of the invention is to provide a hybrid power train drive system that includes a selectable drive for hydraulic pumps or other auxiliary devices that can be selectively powered by the heat engine or an electric motor/generator.

Yet another aspect of the invention is the provision of a hybrid power train system having a selectable auxiliary drive for hydraulic motor/pump operation, and with an energy storage accumulator to selectively provide a hydraulic power boost, thus creating the opportunity for power drive by heat engine, electric motor, or hydraulic motor.

A further aspect of the invention is the provision of a post-transmission parallel hybrid power train module that has two or more speed capabilities between an electric motor and the vehicle output to provide higher torque and acceleration at low speeds while allowing the motor to match torque requirements at intermediate or high speeds.

Yet an additional aspect of the invention is the provision of a post-transmission parallel hybrid power train module that includes an input disconnect to allow an electric motor to power the vehicle without the engine and transmission running.

Still a further aspect of the invention is the provision of a post-transmission parallel hybrid power train module that includes an output disconnect to allow the engine to drive an electric motor as a generator to recharge the vehicle battery with the vehicle stationary, and to provide exportable power for other uses.

Another aspect of the invention is the provision of a post-transmission parallel hybrid power train module that provides direct drive between a main power source and output to achieve the highest engine drive efficiency when the vehicle is operating at highway speeds.

Another aspect of the invention is to provide a post-transmission parallel hybrid power train module that includes an auxiliary low-speed transmission with multiple speed capabilities to accommodate movement when extremely low speeds or high torque are required.

The foregoing and other aspects of the invention that will become apparent as the detailed description proceeds are achieved by a post-transmission parallel hybrid drive module for a vehicle, comprising: an AC induction motor having a motor shaft extending therethrough, said motor shaft having a rotor attached thereto, said rotor being received within an array of stator windings, and said motor receiving cooling oil over opposite ends of said rotor and onto said stator windings; a sump adjacent said motor for receiving cooling oil from said windings; an input and an output shaft adapted at opposite ends thereof for interposition within a drive shaft of a vehicle; a gear assembly interposed between said motor shaft and output shaft for selective driving engagement therebetween; and a selective disconnect between said input and output shafts.

Other aspects of the invention are achieved by a hybrid drive module for vehicles, comprising: a motor having a motor shaft; an output shaft adapted at opposite ends thereof for interposition within a drive shaft of a vehicle, said drive shaft having an input shaft portion and a remaining portion; a first gear assembly interposed between said motor shaft and output shaft; a first shift assembly interposed with said first gear assembly for effecting selective driving engagement between said motor shaft and output shaft; and a second shift assembly interposed between said input shaft portion and and said remaining portion for selective driving engagement between said portions.

Still additional aspects of the invention are achieved by a multiple electric motor/generator drive system for vehicular propulsion, comprising: a first motor/generator operatively positioned at, and offset from, an input of a multiple speed actuator controlled gearing system; and a second motor/generator operatively positioned at, and offset from, a point of said multiple speed actuator controlled gearing system beyond said first motor/generator and toward an output thereof.

### DESCRIPTION OF DRAWINGS

For a complete understanding of the various aspects of the invention, along with the structure and method of operation associated therewith, reference should be made to the following detailed description and accompanying drawings wherein:

FIG. 1 is a front elevational view of the oil cooled electric drive module for hybrid vehicles made in accordance with the invention;

FIG. 2 is a cross sectional view of the assembly of FIG. 1, taken along the line 2-2;

FIG. 3 is a cross sectional view of the assembly of FIG. 1, taken along the line 3-3;

FIG. 4 is a cross sectional view of an alternate embodiment of the invention, showing the implementation of an auxiliary pump manifold;

FIG. 5 is a schematic diagram of the implementation of the auxiliary pump manifold of FIG. 4;

FIG. 6 is a schematic diagram of a series/parallel hybrid power train module made in accordance with the invention;

FIG. 7 is a cross sectional view of a dual hydraulic shift mechanism for dual shift locations, shown in the neutral position;

FIG. 8 is a cross sectional view of the mechanism of FIG. 2, showing the shift mechanism in one of two engaged positions; and

FIG. 9 is a functional block diagram of the control circuit for gear synchronization for the module and shift mechanism of the invention.

### BEST MODE FOR CARRYING OUT THE INVENTION

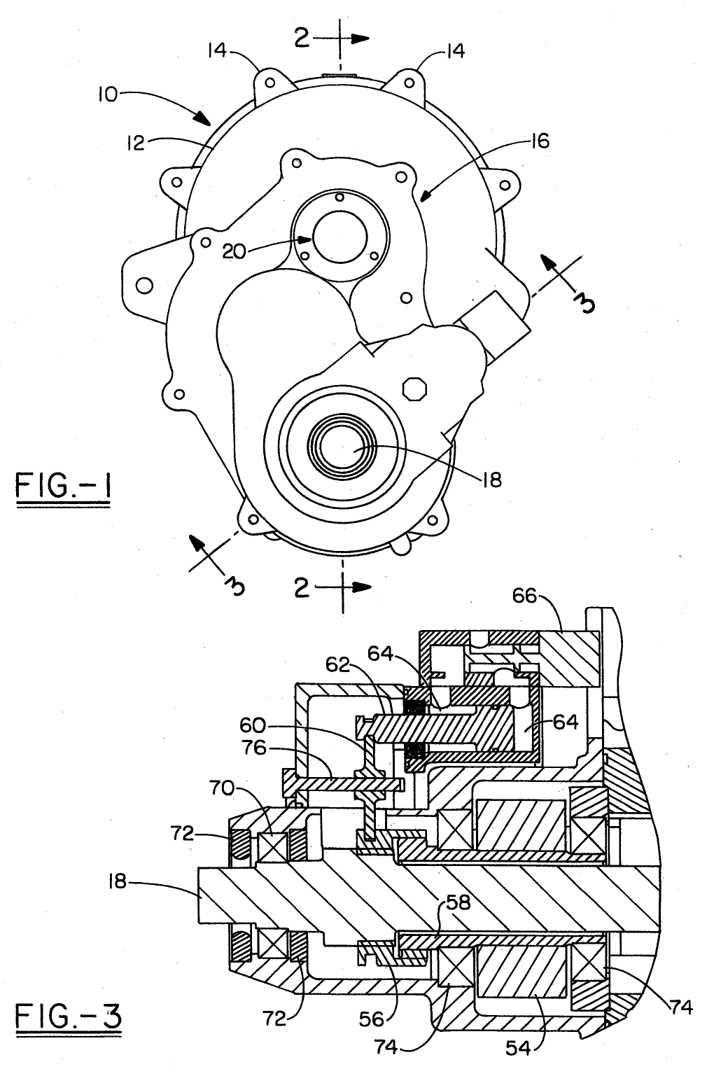

Referring now to the drawings and more particularly FIGS. 1-3, it can be seen that an oil cooled electric drive module for hybrid vehicles is designated generally by the numeral 10. The module 10 includes a housing 12, typically made of aluminum or the like. The housing 12 is characterized by mounting flanges or ears 14 provided thereabout and suitable for mounting of the module 10 to a desired vehicle. A housing cap 16, also preferably of aluminum, is bolted to the housing 12, as shown.

Received within the housing 12, comprising halves 12a and 12b, is a drive shaft or output shaft 18, having respective ends 18a, 18b adapted for interconnection with the drive shaft of a vehicle. In other words, the drive shaft 18 is adapted to be interposed within the drive shaft of the vehicle, beyond the vehicle's transmission, and interconnected therewith through universal joints or the like at 18a and 18b. Also received within the housing 12 and maintained in parallel relationship to the drive shaft 18, is a motor shaft 20 of a motor having a squirrel cage configuration. The motor includes a stator core 22 having stator windings 24 thereabout in standard fashion, the stator core and windings being fixedly retained in the housing 12. A rotor base 26, of standard fashion, is connected to the motor shaft 20 and is rotatable therewith. In standard fashion, conducive bars 28 extend axially across the rotor base 22 and are interconnected as by shorting rings 30 at the lateral ends thereof.

Appropriate bearings 32 are provided at opposite ends of the motor shaft 20 for rotational support. A speed sensing bearing 34, appropriately encoded or otherwise graduated for producing signals corresponding to rotational speed, is provided at one end of the motor shaft 20. At the opposite end, an oil distribution ring assembly or rotary union is attached to the motor shaft 20 and is provide in communication with an axial bore 38 extending thereinto. The axial bore 38 extends to and communicates with a radial bore 40 that extends outwardly into communication with the outer circumferential surface of the motor shaft 20. A plurality of axial splines or reliefs 42 are provided in the circumferential surface of the motor shaft 20 and extend between end rings 44, provided at each end of the rotor base. The end rings 44 are in the form of annular disks, washers, deflectors or the like. This structure and arrangement provides an important pathway for cooling oil to enter the motor shaft 20 at the oil distribution ring or rotary union 36, to pass through the axial bore 38, outwardly through the radial bore 40, and into the space between the shaft 20 and rotor base 26. The plurality of axial splines or reliefs 42 provided in the circumferential surface of the shaft 20 direct the cooling oil outwardly between the shaft and rotor base to the end rings 44, where the cooling oil is redirected radially by such deflectors at the end of the rotor. There, the cooling oil is centrifugally spun outwardly with a coanda effect that coats the aluminum or copper shorting rings 30 on the end faces of the rotor. This oil is centrifugally thrown off of the rotor directly into the stator windings 24 to then flow downwardly through the motor to drain holes 46 in the aluminum housing 12 and into a recovery and recirculating sump 48, that receives the drive shaft 18. A drain 50 is provided within the sump 48 to return the cooling oil to an appropriate pump, auxiliary heat exchanger, or the like for redistribution back through the assembly 10 or other units associated with the vehicle.

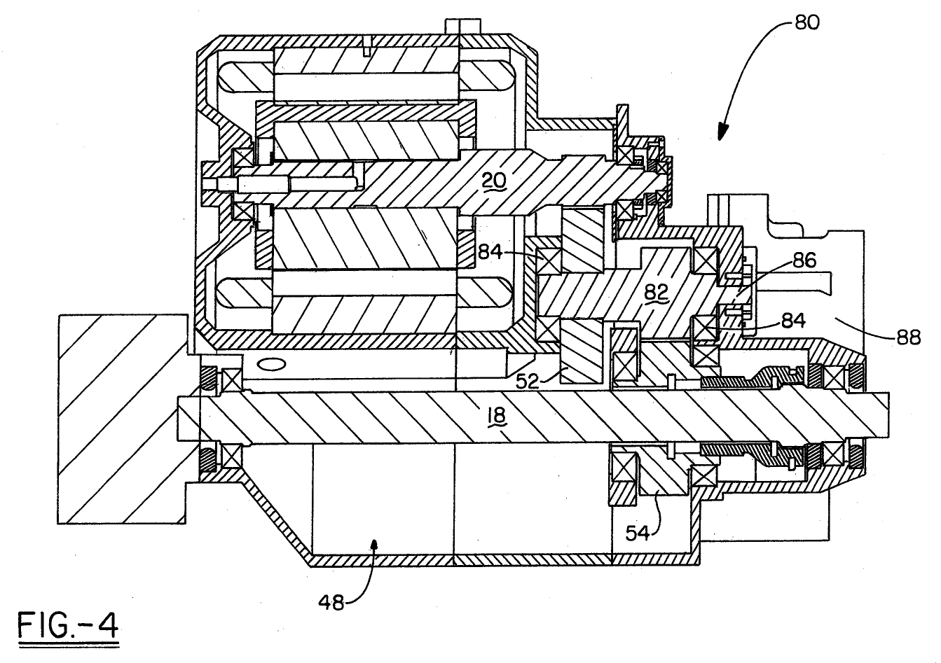

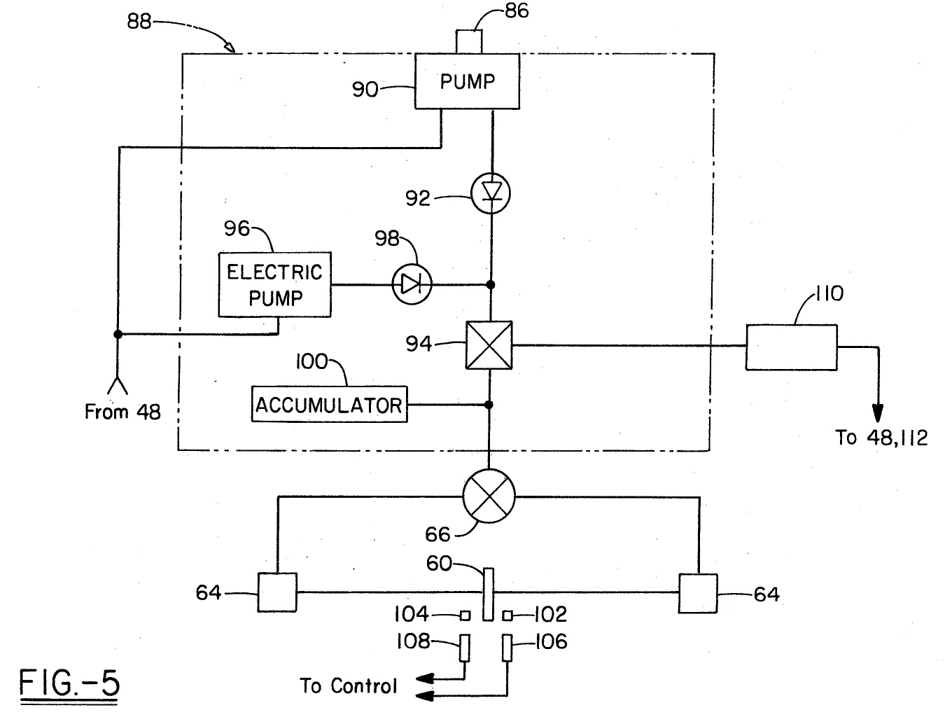

The invention employs a gear reduction set between the motor shaft 20 and output shaft 18 to tailor the motor speed to a desired output speed. In one embodiment, the gear set includes a first stage helical gear 52 in driving connection through gear teeth with the motor shaft 20. Those skilled in the art will understand that the first stage helical gear 52 is connected through an appropriate gear drive shaft ( shown in FIG. 4) to a second stage helical gear 54 which, in turn, is selectively connected to the output shaft 18 through an appropriate mechanical disconnect mechanism 56, best shown and described with regard to FIG. 3.

The mechanical disconnect mechanism 56 is operatively connected to a splined collar 58 that is interposed between the second stage helical gear 54 and the output shaft 18. The collar 58 is axially slidable with regard to both the output shaft 18 and gear 54 to selectively engage and disengage the two. An actuator arm 60 is interconnected with the mechanical disconnect mechanism 56 and driven by a hydraulic piston 62 upon a slide 76, as shown. The piston 62 is received by a hydraulic cylinder 64, having dual cavities to both extend and retract the piston 64 with respect thereto. Accordingly, the piston 62 is capable of engaging and disengaging the collar 58 through the disconnect mechanism 56 and associated actuator arm 60. A solenoid valve 66 is electrically operated to selectively actuate the piston 64 in either the engage or disengage direction.

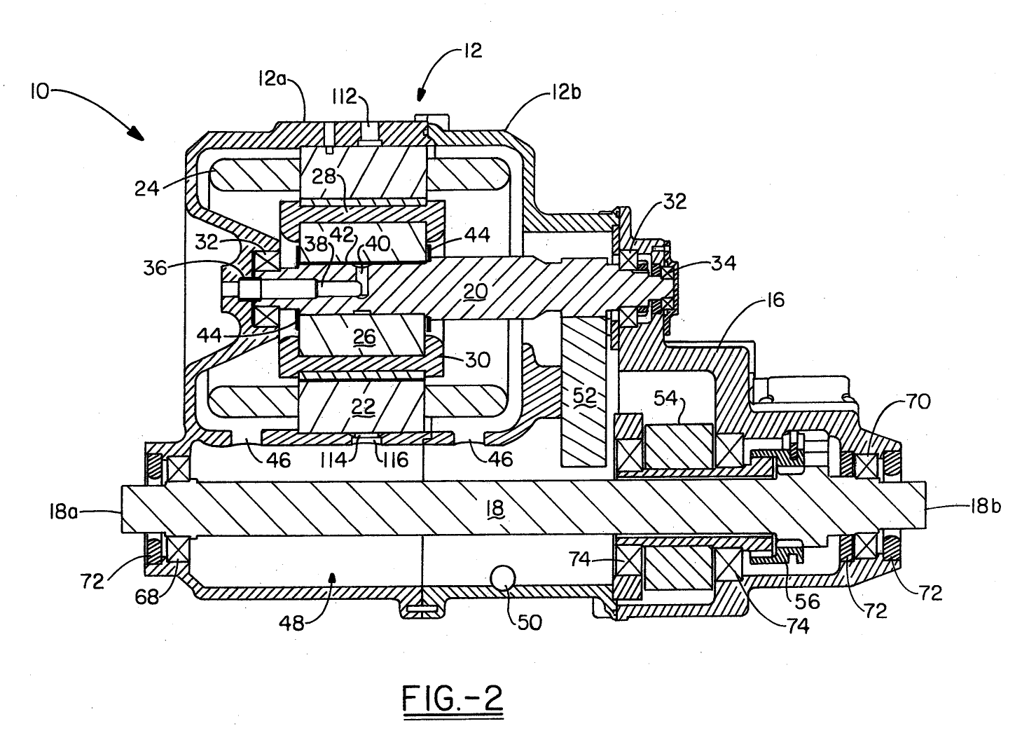

As shown in FIG. 2, the output shaft 18 is supported at opposite ends 18a, 18b by an appropriate bearing 68. A speed sensing bearing 70, similar to the bearing 34, is provided at the end 18b, as shown. Appropriate keepers or seals 72 are provided at opposite ends of the output shaft 18 for purposes of sealing and maintaining the shaft 18 within the housing 12, 16, as shown. Appropriate bearings 74 are provided for the splined collar 58 and second stage gear 54.

In use, it will be appreciated that the solenoid valves 66 may be employed to selectively engage/disengage the motor drive from the output shaft 18. The timing of the engagement/disengagement is achieved by correlation of the outputs of the speed sensing bearings 34, 70. When disengaged, the output shaft 18 is driven solely by the heat engine of the vehicle. When engaged, the motor drive mechanism either provides sole power to the vehicle (in which case the heat engines are disengaged from the output shaft 18) or the motor is used to supplement that power. Of key importance is the ability to provide an AC motor structure that can be effectively cooled in order to ensure optimum efficiency in a small, light weight, cost effective envelope. The provision of an oil distribution ring assembly or rotary union 36 in association with axial and radial bores 38,40, coupled with the implementation of axial splines or reliefs 42 and end ring deflectors 44 to provide a coanda sheeting of cooling oil across the end surface of the rotor which is then centrifugally spun outwardly onto the stator of the motor, and its housing, providing for effective cooling that optimizes motor performance.

FIG. 4 presents an alternative embodiment of the invention, similar in most respects to the embodiment presented in FIGS. 1-3, but with the addition of an auxiliary pump manifold to further optimize the cooling required for improved performance. This second embodiment 80 shows the presence of the gear drive shaft 82 interposed between the first and second stage helical gears 52, 54 and maintained upon bearings 84. This gear drive shaft 82 is provided with an output head 86 to provide power to an auxiliary pump manifold 88, illustratively shown as connected thereto.

As shown in FIG. 5, the output head 86 of the gear drive shaft 82, operatively driven by the motor shaft 20, provides motor force to the auxiliary pump manifold 88, that includes a hydraulic pump 90, receiving cooling oil from the sump 48. The cooling oil is driven by the pump 90 through a check valve 92 and thence to a pressure relief valve 94, as shown. Also included within the auxiliary pump manifold 88 is an electric pump 96, similarly connected to the sump 48 for receiving cooling oil therefrom and passing it through the check valve 98 and the pressure relief valve 94. Accordingly, both mechanically and electrically driven pumps 90, 96 are provided for purposes of cooling oil recirculation and provision to the solenoid valves 66 responsible for engagement and disengagement of the electric motor power source with the output shaft 18. The output of the pressure relief valve 94 is provided to an accumulator 100, in somewhat standard fashion. The output of the accumulator 100 is interconnected with the solenoid valves 66 for selectively pressurizing the hydraulic cylinder 64 for driving the actuator arm 60 in a selected direction to effect engagement or disengagement of the motor shaft 20 with the output shaft 18.

A pair of permanent holding magnets 102, 104 is employed to hold the actuator arm 60 in a desired position, once moved by the piston 62. Accordingly, the piston, cylinders, and solenoid valve 66 are employed to move the actuator arm 60 to either engage or disengage the output shaft 18 with the second stage gear 54, and the actuator arm 60 is then maintained in that position by an appropriate holding magnet 102, 104 such that the hydraulic pressure can be released, and not reapplied until opposite shifting is desired. In that regard, proximity sensors 106, 108 are provided in association with the actuator arm 60 or other associated movable element, to sense that the desired shifting has occurred and then signal through an appropriate control mechanism that the solenoid valves 66 can be released for removal of the hydraulic pressure.

The instant invention further contemplates that an auxiliary heat exchanger 110 may be interposed between the pressure relief valve 94 and the sump 48 for further cooling efficiency. The heat exchanger 110 may be of any suitable nature, such as a radiator, finned housing, cooling jacket or the like. The necessity of transferring heat from the motor assembly to the ambient is of primary importance to ensure optimum effective operation of the motor. In keeping with such efforts to maximize and optimize cooling of the drive motor, it is further contemplated as a portion of the cooling oil recirculation that the output of the pump 90 or heat exchanger 110 might also provide additional cooling to the stator core 22 and windings 24. To that end, as shown in FIGS. 2 and 5, the output of the heat exchanger 110 may pass to the stator core inlet 112, through the circumferential cooling path 114 encircling the stator core 22, out of the drain 116 and into the sump 48.

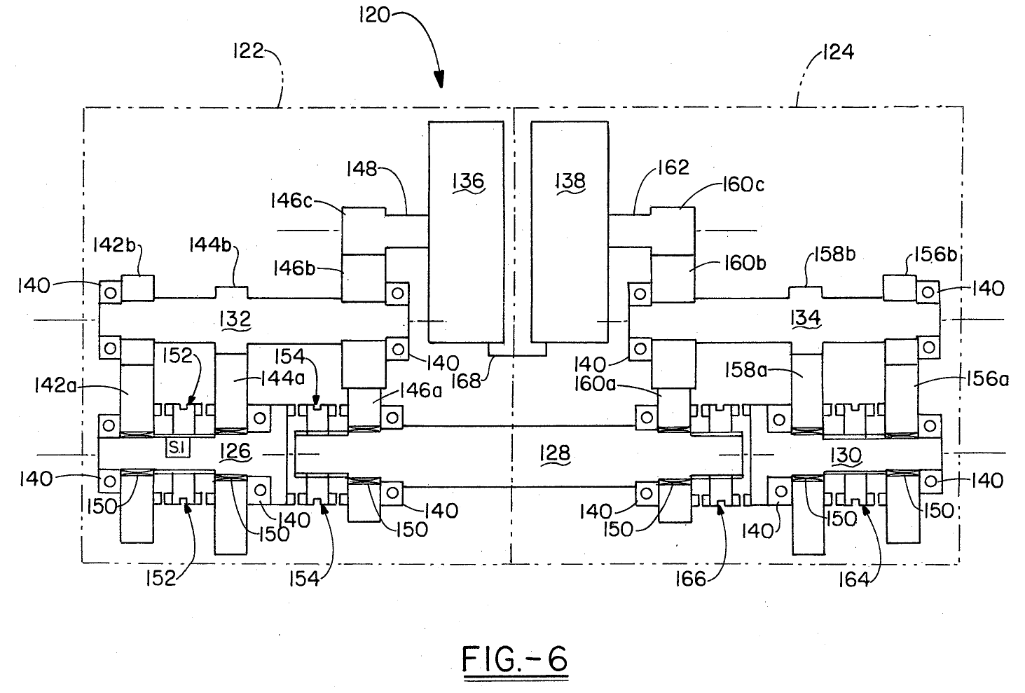

Referring now to FIG. 6, it can be seen that a hybrid drive module for vehicles made in accordance with the invention is designated generally by the numeral 120. The module 120 includes an input side oil cooled electric drive module 122, and an output side oil cooled electric drive module 124, the two being substantially mirror images of each other, and of the general type presented above with regard to FIGS. 1-5. The module 120 has an input shaft 126, typically tied to a heat engine or other power source for a vehicle or other drive equipment, as would be appreciated by those skilled in the art. Adapted for interconnection to the input shaft 126 is an intermediate shaft 128, which is similarly adapted for selective interconnection with an output shaft 130. Again, those skilled in the art will appreciate that the output shaft 130 may be connected to a differential, wheel axle, or other driven member as required. It should be noted that the shafts 126-130 are preferably coaxially aligned, allowing for direct interconnection therebetween, as will be appreciated later herein.

The input side module 122 includes an input secondary shaft 132 adapted for selective interconnection with the input shaft 126 and intermediate shaft 128. In similar fashion, the output module 124 includes an output secondary shaft 134 adapted for selective interconnection with the intermediate shaft 128 and output shaft 130.

The input module 122 includes a motor/generator 136 and, in like fashion, the output module 124 includes a motor/generator 138. Those skilled in the art will readily appreciate that a motor/generator selectively operates as either a motor, receiving an electrical input and converting it to a mechanical output, or as a generator, in which a mechanical input is converted to an electrical output. The motor/generator contemplated for use herein may be of various types as would be appreciated by those skilled in the art, but is preferably of the oil cooled electric drive module type as presented and described above. The mechanical inputs and outputs of the motor/generators 136, 138 connect through the respective shaft 132, 134 as selectively interconnected with the shafts 126,130 as will be discussed below. The shafts are all rotatable upon appropriate bearing mount assemblies 140, as will be readily appreciated by those skilled in the art.

With continued reference to FIG. 6, it can be seen that a gear 142a, rotatably mounted upon shaft 126, interconnects with gear 142b, which is fixed to or integral with the input secondary shaft 132. In like manner, gear 144a is rotatably received upon the input shaft 126 and is operatively interconnected with mating gear 144b which is integral with or fixed to the secondary shaft 132. Finally, gear 146a is rotatably received upon intermediate shaft 128 and meshes with gear 146b which is fixed to or integral with secondary shaft 132. The gear 146b meshes with and drives the gear 146c, which is integral with or fixed to the shaft 148 of motor/generator 136, as shown.

The gears 142a, 144a, 146a are mounted upon the respective shafts 126, 128 and are freely rotatable thereon by means of associated bearings 150. These gears may, however, be selectively connected to and rotatable with the associated shaft 126, 128 by means of associated shift assemblies 152, 154. Those skilled in the art will appreciate that the shift assemblies 152, 154 are slidably received upon splines of the associated shafts 126, 128 for axial movement in association therewith and may be of any suitable nature known to those skilled in the art including, by way of example, dog clutches. Those skilled in the art will appreciate that dog-type clutches are preferred because they exhibit near-zero drag when disengaged. The shift assembly 152 may be shifted to the left as viewed in FIG. 6 to engage the gear 142a with the shaft 126, or to the right to engage the gear 144a with that shaft. The shift assembly 152 is shown in its neutral position in FIG. 6, with neither of the gears 142a or 144a engaged. In like manner, the shift assembly 154, shown in its neutral position in FIG. 6, may be shifted to the left to engage the input shaft 126 with the intermediate shaft 128, or to the right to engage the shaft 128 with the gear 146a. It will be appreciated by those skilled in the art that the shift assemblies 152, 154 include some appropriate mechanism such as cogs, mating locking members or the like to engage with similar cogs or mating locking member when the gears 142a, 144a, 146a, are on the end of the input shaft 126, as illustratively shown in the drawing. Standard dog clutches engaged by a yoke and collar may be employed.

It should further be appreciated that the gear ratio achieved between the shafts 126, 132 by means of the gears 142a, 142b, is typically different from the gear ratio between the gears 144a and 146b. Accordingly, the shift assembly 152 selects between two gear ratios for interconnection between the shafts 126, 132. The shift assembly 154 merely selects between interconnection between the shafts 126, 128 or interconnection between the shaft 128 and the shaft 132. It will be appreciated that the shafts 148 and 132 may be interconnected through gears 146b and 146c or, alternatively, an additional gear may be added to shaft 132 for making engagement with gear 146c if a different gear ratio is desired. With continuing reference to FIG. 6, it can be seen that the output side module 124 is substantially a mirror image of the input side module 122. In this regard, a gear 156a is rotatably mounted upon the output shaft 130 and freely rotatable thereon by means of a bearing 150. The gear 156a is adapted to mesh with gear 156b, which is fixed to or integral with the output secondary shaft 134. In similar fashion, gear 158a is rotatably mounted upon the shaft 130 through a bearing 150 and meshes with gear 158b which is shown as an integral part of the output shaft 134. Finally, gear 160a is rotatably mounted upon the intermediate shaft 128 and meshes with gear 160b, which is integral with or fixed to the output secondary shaft 134. The gear 160b meshes with gear 160c, which is integral with or fixed to the shaft of the motor/generator 138. Shift assemblies 164, 166, similar to shift assemblies 152, 154 are provided in association with the module 124. As shown, both shift assemblies 164, 166 are in the neutral position. The shifter 164, axially splined to and slidable upon the output shaft 130, is adapted to selectively interconnect the shaft 130 with the gear 156a, or the gear 158a, such interconnections being mutually exclusive. Again, the gear ratio achieved between the gears 156a and 156b and that achieved between the gears 158a and 158b are necessarily different. It will be appreciated that the shafts 162 and 134 may be interconnected through gears 160b or, alternatively, an additional gear may be added to shaft 134 for meshing engagement with gear 160c if a different gear ratio is desired.

The shift assembly 166 is adapted to selectively interconnect the intermediate shaft 128 with the output shaft 130 when actuated to the right as shown in FIG. 6, or alternatively interconnect the intermediate shaft 128 with the output secondary shaft 134 when shifted to the left.

Those skilled in the art will appreciate that a module 120, comprising input and output modules 122, 124 and the segmented shaft 126, 128, 130 is capable of a multitude of geared interconnections and, accordingly, various modes of operation, as will be the discussed below. It should be noted that the only interconnection between the motor/generator assemblies 136, 138 is an electrical interconnection shown as 168 in FIG. 6. Otherwise, apart from sharing the intermediate shaft 128, the modules 122, 124 are separate and distinct from each other, although they may be housed together side-by-side, with the motor shafts parallel to each other, as space constraints dictate.

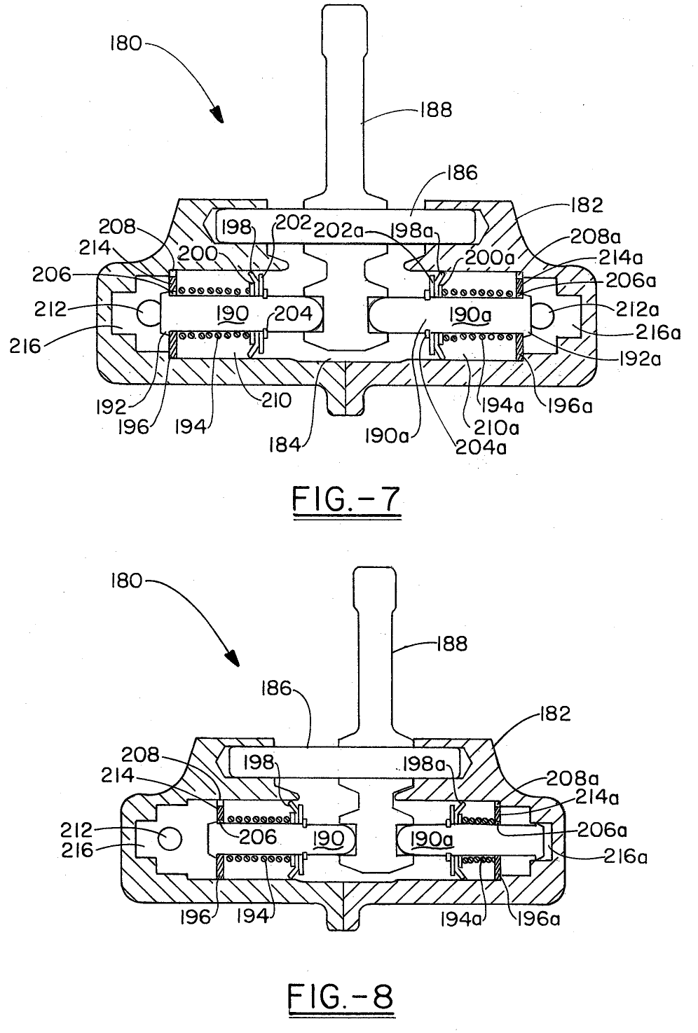

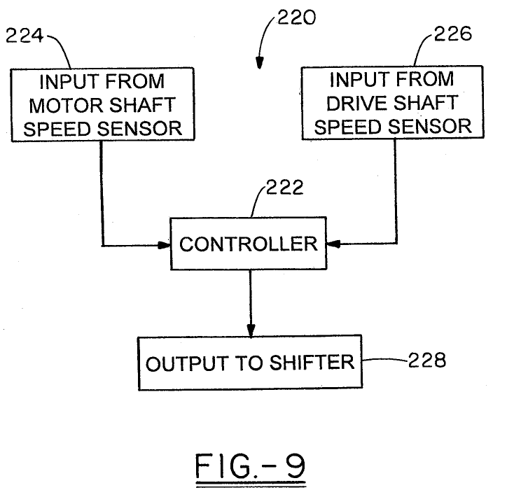

With reference now to FIGS. 7 and 8, an appreciation can be had with regard to the shift assemblies 152, 154, 164, 166 as presented above. Specifically, it can be seen that a dual shift assembly such as those employed in the embodiment of FIG. 6 is shown in operative cross section in FIG. 7 and designated generally by the numeral 180. The shift assembly 180 includes a housing 182 defining a hydraulic cavity 184 therein. A guide pin 186 is received by the housing 182 and slidably receives a yoke 188 thereon. Those skilled in the art will appreciate that the yoke 188 is adapted to shift a shifting collar that engages dog clutches on either side to effect the release and engagement of gears to the shafts 126, 128, 130 or to effect the interengagement of the intermediate shaft 128 with the input shaft 126 and/or output shaft 130. Such dog clutches are well known and understood by those skilled in the art.

Urged against the body of the yoke 188 is a pair of oppositely disposed pins 190, 190a, each having a respective head 192, 192a on opposite ends thereof. Springs 194, 194a are maintained about the respective pins 190, 190a and are captured between washer 196, 196a at the end having the head 192, 192a thereon, and an assembly at the opposite end comprising piston seals 198, 198a sandwiched between respective washers 200, 200a and 202, 202a, and maintained upon the pin by respective keepers 204, 204a. Preferably, the springs 194, 194a are precompressed upon the respective pins 190, 190a.

It will be noted that the washers 196, 196a have respective inner circumferential partial notches 206, 206a therein and outer circumferential partial notches 208, 208a therein, for purposes that will become apparent herein.

Cylinders 210, 210a are defined within the cavity 184 to respectively receive piston assemblies 190-208 and 190a-208a, as shown. Each of the cylinders has a respective aperture for hydraulic fluid, serving both as a source and a drain of pressurized hydraulic fluid, designated by the numeral 212, 212a. Finally, it will be appreciated that the cylinders 210, 210a are characterized by stops 214, 214a adapted to engage the washers 196, 196a, and necked-down cylinder end portions 216, 216a for receiving respective heads 192, 192a of the pins 190, 190a as will become apparent herein.

The neutral state of the shift assembly 180 is shown in FIG. 7, where the washers 196, 196a are urged into contacting engagement with respective stops 214, 214a, and without the application of hydraulic pressure through the apertures 212, 212a. The neutral position is automatically achieved by the precompressed springs 194, 194a of the piston assemblies. Actuation of the yoke 188 to the right as shown in FIG. 8 is achieved by the application of hydraulic pressure though the aperture 212, which passes through the notch 208 and against the piston seal 198, driving the piston assembly 190-208 to the right. With the aperture 212a open and acting as a drain, the hydraulic fluid contained within the cylinder 210a is driven ahead of the piston seal 198a and through washer 196a and out of the drain 212a. The pin heads 192, 192a are sized for a close-clearance fit in the necked-down cylinder ends 216, 216a such that a cushioning effect is achieved at the end of the shifting stroke, when the head 192a is received by the cylinder end 216a. The pressurized fluid escapes past the clearance between the head 192a and the walls of the cylinder end 216a and out of the drain 212a. Accordingly, rapid shifting to the right or left is achieved without associated slamming or shock load. It will be appreciated that the same type of operation would have occurred had the shift been to the left rather than the right. In returning to the neutral position, the aperture 212 serves as a drain as the further compressed spring 194a urges against the pin 190a, driving the yoke 188 to the left as viewed in FIG. 8. As the assembly shifts toward the position shown in FIG. 7, when the washer 196 bottoms against the stop 214, any compression of the spring 194 by further movement of the piston seal 198 is accommodated by the inner circumferential notch 206, which is stationary upon bottoming against the stop 214, while the head 192 separates therefrom, providing a path for passage of hydraulic fluid maintained within the piston, thus cushioning the stop. Accordingly, the inner circumferential notches 206, 206a serve to cushion when returning to a neutral position or passing therethrough, while the outer circumferential notches 208, 208a allow for passage of hydraulic fluid into the piston and against the respective piston seals 198, 198a during actuation. The close tolerance sizing of the heads 192, 192a with respective cylinder ends 216, 216a to allow bleed by of hydraulic fluid upon nesting provides for cushioning when shifting into either of the activated positions. Accordingly, the shifting of the mechanism of FIG. 6 can be obtained rapidly and smoothly, without loss of power, capacity or comfort.

The efficiency of the operation of the shift assemblies 180 is enhanced by the synchronization attained by the control circuit 220, shown in FIG. 9. As shown, the controller 222, such as a chip or dedicated microprocessor, is interposed among the motor shafts, drive shafts and associated shaft assemblies to effect shift synchronization. As presented in FIGS. 2 and 3, the motor shafts 20 may be provided with speed sensor bearings 32, and the output shafts 18 with speed sensor bearings 70, the same providing respective inputs 224, 226 to the controller 222. In turn, a control output 228 is provided to the shaft assemblies 180 to synchronize the interengagement of the associated gears.

The efficiency of the operation of the system of the invention is further enhanced by a gear shifting sequence that ensures that one of the motor/generators 136, 138 maintains driving power to the associated vehicle while gears associated with the other are shifted. Such efficient operation is further enhanced by the use of helical and/or spur gears mounted on parallel shafts and shifted by dog-type clutches slidable upon shafts.

With an appreciation of the structure of the elements of the invention, an understanding can now be obtained with regard to its operation and the multiple capabilities of the series/parallel hybrid drive module for vehicles presented above. As a start, it will be appreciated that the output side oil cooled electric drive module 124 may have a similar motor generator 138 and gearing as presented with regard to FIGS. 1-5, with the addition of a selectable set of two output speeds, utilizing shift assembly 164 that allows selectability between the gear ratios associated with gears 156a, 156b and gears 158a, 158b as between the output secondary shaft 134 and the output shaft 130. Of course, it will be appreciated that the shift assembly 164 may also be selectively placed in the neutral position to fully disengage the motor/generator assembly 138 from the output shaft 130.

The shift assembly 166 allows direct engagement of the intermediate shaft 128 to the output shaft 130. If the output side module 124 were to be used without the input side 122, intermediate shaft 128 would be the input shaft connecting it to the output of a vehicle's engine or transmission, or other appropriate power source. The shift assembly 166 can also selectively disengage the output shaft 130 and engage the gear mesh 160a, 160b to drive the motor generator assembly 138 for purposes of electrical energy generation from the heat engine.

Shift assembly 166 may also be placed in a neutral position to disengage the output shaft 130 and the motor generator assembly 138 from the intermediate shaft 128, and thus from the engine or other input power source. In the neutral position, the motor generator 138 is available to drive the output shaft 130, and the associated vehicle or other device, without heat engine operation or other power input.

As presented above, the input side oil cooled electric drive module 122 is substantially a mirror image of the module 124, although the gear mesh ratios may differ. The shift assembly 152 is operative to select between gear shift ratios 142a, 142b and 144a, 144b to cause the input shaft 126, preferably driven by a heat engine, to drive the input secondary shaft 132, which in turn drives the motor generator assembly 136 through the gear ratio 146b, 146c. Alternatively, the motor generator 136 may drive the input secondary shaft 132 through the gear mesh 146b, 146c and selectively drive the input shaft 126 through one of the engaged meshes 142a, 142b and 144a, 144b. It will be noted that the shift assembly 152 also has a neutral position, in which case the gears 142a, 144a are freewheeling on the input shaft 126.

Shift assembly 154 is adapted to selectively interengage the input shaft 126 with the intermediate shaft 128 through a direct connection at a 1:1 ratio. Alternatively, the shift assembly 154 may interconnect the input secondary shaft 132 to the intermediate shaft 128 and thereby gain two additional speed ratios from gear meshes 142a, 142b and 144a, 144b which may be selectively interconnected to the input secondary shaft 132.

Those skilled in the art should recognize that the output side module 124 may serve as an independent system adapted to join with an engine/transmission to provide a hybrid vehicle on its own. In like manner, the input side module 122 may be employed to replace the transmission on any engine for any vehicle without an output side module 124. The output side module 124 and the input side module 122 may find separate and independent use in various vehicles, or may be joined together as two independent units, such that with integrated control of the two units, a broad range of benefits can be obtained.

It will further be appreciated that the input secondary shaft 132 and output secondary shaft 134 may, in various employments, drive hydraulic pumps or otherwise power hydraulically actuated axillary equipment or, indeed, act as a hydraulic motor to aid in vehicle propulsion and acceleration, as the need may present itself.

Having considered the input side module 122 and output side module 124 separately, it will be appreciated that their operation in the total system 120 is in conjunction with a segmented drive shaft 126, 128, 130, as shown. It is contemplated as a portion of the invention that the segmented shaft, or portions thereof, may selectively drive or be driven by associated motor generators 136, 138 under control of the shift assemblies 152, 154, 164, 166, as described above. It is also contemplated that when employed in vehicle use, and particularly at highway speeds, the shift assemblies 154, 166 are shifted such that a direct interconnection is achieved between the input shaft 126 and intermediate shaft 128, as well as the intermediate shaft 128 and output shaft 130, all being made with a preferred 1:1 ratio. In this way, when the vehicle is operating at highway speeds, optimum efficiency of the heat engine can be enjoyed.

With further reference to the system of FIG. 6, it will be appreciated that the output side module 124 allows for the capability of two or more speeds between the electric motor of the motor generator assembly 138 and the vehicle output through the shaft 130 to accommodate high torque and acceleration at low speed, while allowing the motor to also match these torque requirements at intermediate or higher speeds. In other words, by having the capability of selecting various gear ratios, a vehicle such as a refuse truck may operate at a first speed such as 10 mph through one gear ratio and a second speed such as 25 mph at a second ratio, or at highway speeds with the shafts 126, 128, 130 interconnected as by shift assemblies 154, 166.

The system 120 further allows the output module 124 to enable the electric motor of the motor generator 138 to power the vehicle without the associated heat engine and transmission running. The shift assembly 166 may simply disconnect the intermediate shaft 128 and the output shaft 130, allowing the output secondary shaft 134 to control operation of the output shaft 130 at a gear ratio selected by the shift assembly 164. This operation, being totally electric, is ideal for urban operation with no environmental emissions from the vehicle, or for use in stealth operations for military vehicles or the like.

The invention further contemplates a disconnect of the output shaft 130 from the intermediate shaft 128, allowing the heat engine to drive the motor generators 136, 138 through the intermediate shaft 128, to provide for electric power generation and recharging of the vehicle batteries without moving the vehicle, such as overnight stays of semi-tractor trailers, or to provide for exportable power for use by emergency and military vehicles and the like.

As presented above, disconnect of the input side module 122 and output side module 124 may be achieved with the system 120, allowing interconnection of the segments 126, 128, 130 of the shaft assembly of the invention, and thus a straight through drive to the heat engine when the associated vehicle is operating at highway speeds, or when the load on other drive equipment is minimized. Accordingly, the system 120 may completely disconnect the motor/generators of the modules 122, 124, eliminating the idling gears, and the associated losses common in multiple speed transmissions.

The system 120 further accommodates extremely low speed operation with multiple speed capability in order to provide for exceptionally low speeds with high operational torque. The various gear ratios achievable through selection of various shift assemblies 152, 154, 164, 166 allow the downsizing of the heat engine and a reduction in the number of speeds of the associated transmission in order to achieve the same operational capabilities. For example, where a truck required a 450 horsepower engine with an 18 speed transmission, with the implementation of a system comprising the output side module 124 in association with the heat engine of the truck, before or after its transmission, the engine size may be reduced from 450 horsepower to 300 horsepower, with the transmission being reduced from an 18 speed transmission to a 6 speed transmission. All of this may be achieved by simply adding a three speed output module 124, with 150 horsepower peak power. By replacing the truck transmission with system 120, with both motors 136, 138 at a peak of 150 horsepower, further economies may be enjoyed with a heat engine of less than 200 horsepower.

It will be readily appreciated by those skilled in the art that the system 10 may be readily packaged in the space saved by the reduction in necessary gearing and engine size of previously employed vehicles. Those skilled in the art will further appreciate that any of numerous combinations of employment of the motor generators 136, 138 at various gear ratios, with or without the assistance of each other, and with or without the assistance of the heat engine itself, may be employed to maximize operational efficiency, minimize pollutant emissions, reduce engine size and complexities, provide for electric power generation for auxiliary equipment, and provide for the generation of hydraulic power sources for the operation of auxiliary hydraulic equipment.

Thus it can be seen that the various aspects of the invention have been satisfied by the structure presented above. While in accordance with the patent statutes only the best known and preferred embodiment of the invention have been presented and described in detail, the invention is not limited thereto or thereby. Accordingly, for an appreciation of the true scope and breadth of the invention reference should be made to the following claims.

What is claimed is:

1. A post-transmission parallel hybrid drive module for a vehicle, comprising:
an AC induction motor having a motor shaft extending therethrough, said motor shaft having a rotor attached thereto, said rotor being received within an array of stator windings, and said motor receiving cooling oil over opposite ends of said rotor and onto said stator windings;
a sump adjacent said motor for receiving cooling oil from said windings;
an input and an output shaft adapted at opposite ends thereof for interposition within a drive shaft of a vehicle;
a gear assembly interposed between said motor shaft and output shaft for selective driving engagement therebetween; and
a selective disconnect between said input and output shafts.

2. The post-transmission parallel hybrid drive module for a vehicle according to claim 1, wherein said gear assembly comprises gears of two different gear mesh ratios for selective driving engagement at two speed ratios.

3. The post-transmission parallel hybrid drive module for a vehicle according to claim 2, further comprising a shift assembly interposed with said gear assembly, said shift assembly having a neutral position between said gear ratios.

4. The post-transmission parallel hybrid drive module for a vehicle according to claim 3, wherein said shift assembly comprises a single sliding element selectively engaging said two different gear mesh ratios.

5. The post-transmission parallel hybrid drive module for a vehicle according to claim 4, wherein said shift assembly further comprises a hydraulically actuated shifting yoke and a spring return mechanism, biasing said sliding element to said neutral position.

6. The post-transmission parallel hybrid drive module for a vehicle according to claim 5, wherein said shift assembly further comprises hydraulic cushioning at ends of strokes of said shifting yoke, and at said neutral position.

7. A hybrid drive module for vehicles, comprising:
a motor having a motor shaft;
an output shaft adapted at opposite ends thereof for interposition within a drive shaft of a vehicle, said drive shaft having an input shaft portion and a remaining portion;
a first gear assembly interposed between said motor shaft and output shaft;
a first shift assembly interposed with said first gear assembly for effecting selective driving engagement between said motor shaft and output shaft; and
a second shift assembly interposed between said input shaft portion and said remaining portion for selective driving engagement between said portions.

8. The hybrid drive module for vehicles according to claim 7, wherein said first gear assembly comprises at least two different gear mesh ratios for selective driving engagement in at least two different speed ranges.

9. The hybrid drive module for vehicles according to claim 8, wherein said first shift assembly has a neutral position between said at least two gear ratios.

10. The hybrid drive module for vehicles according to claim 9, wherein said first shift assembly comprises a sliding mechanism operatively interposed between said at least two gear mesh ratios.

11. The hybrid drive module for vehicles according to claim 10, wherein said sliding mechanism comprises a hydraulically actuated shifting yoke, and at least one spring mechanism biasing said shifting yoke to neutral.

12. The hybrid drive module for vehicles according to claim 11, wherein said sliding mechanism receives a pair of pins, each operatively engaging a said spring mechanism operative within respective hydraulic cylinders.

13. The hybrid drive module for vehicles according to claim 12, wherein said spring mechanisms comprise pistons received within said respective hydraulic cylinders, said pistons and cylinders configured to provide hydraulic cushioning at the end of travel of said shifting yoke in a shifting operation.

14. The hybrid drive module for vehicles according to claim 7, wherein said first gear assembly comprises gears supported by bearings upon said output shaft.

15. The hybrid drive module for vehicles according to claim 7, further comprising a second gear assembly between said output shaft and said motor shaft.

16. The hybrid drive module for vehicles according to claim 15, wherein said second shift assembly is interposed with said second gear assembly and operative between said input portion and said remaining portion to selectively engage said motor shaft with said remaining portion or said input portion with said remaining portion.

17. The hybrid drive module for vehicles according to claim 16, wherein said second shift assembly is further characterized by a selectable neutral position, and said second shift assembly is hydraulically actuated and spring biased to said neutral position.

18. The hybrid drive module for vehicles according to claim 17, wherein said second gear assembly comprise a gear rotatably supported by bearings upon said input portion.

19. A multiple electric motor/generator drive system for vehicular propulsion, comprising:
a first motor/generator operatively positioned at, and offset from, an input of a multiple speed actuator controlled gearing system; and
a second motor/generator operatively positioned at, and offset from, a point of said multiple speed actuator controlled gearing system beyond said first motor/generator and toward an output thereof.

20. The multiple electric motor/generator drive system for vehicular propulsion according to claim 19, wherein one of said first and second motor/generators continues to maintain power to an associated vehicle during shifting of gears of said gearing system associated with another of said first and second motor/generators.

21. The multiple electric motor/generator drive system for vehicular propulsion according to claim 20, wherein all gears of said gearing system are mounted on parallel shafts and such gears are chosen from the group of helical and spur gears.

22. The multiple electric motor/generator drive system for vehicular propulsion according to claim 19, wherein said gears are shifted with dog-type clutches, slidable upon said shafts.

23. The multiple electric motor/generator drive system for vehicular propulsion according to claim 22, further comprising a control system sensing motor and shaft rotational speeds and controlling operation of said motor/generators to achieve synchronized gear shifting.

24. The multiple electric motor/generator drive system for vehicular propulsion according to claim 19, further comprising a clutchable input from a heat engine, providing both a series and a parallel hybrid drive system for vehicular propulsion.

25. The multiple electric motor/generator drive system for vehicular propulsion according to claim 24, wherein said heat engine is coupled to an input shaft of said gearing system, said input shaft being coaxial with an intermediate shaft, said intermediate shaft being selectively connected to an input portion of said gearing system

26. The multiple electric motor/generator drive system for vehicular propulsion according to claim 25, wherein said input portion of said gearing system is coupled to said input shaft with a dog clutch for selective engagement and disengagement.

27. The multiple electric motor/generator drive system for vehicular propulsion according to claim 25, wherein said input portion of said gearing system comprises multiple gears for selective engagement among said first motor/generator, input shaft and intermediate shaft.

28. The multiple electric motor/generator drive system for vehicular propulsion according to claim 27, wherein said first and second motor/generators are selectively electrically coupled together to effect a series hybrid drive for vehicular propulsion.

29. The multiple electric motor/generator drive system for vehicular propulsion according to claim 28, said series hybrid drive has multiple selectable gear ratios.

30. The multiple electric motor/generator drive system for vehicular propulsion according to claim 25, wherein said gearing system further comprises an output shaft, said input, intermediate and output shafts being coaxial and selectively interengageable.

31. The multiple electric motor/generator drive system for vehicular propulsion according to claim 30, wherein said input portion of said gearing system comprises an input secondary shaft operatively interposed among said input and intermediate shafts and said first motor/generator.

32. The multiple electric motor/generator drive system for vehicular propulsion according to claim 31, wherein said output portion of said gearing system comprise an output secondary shaft operatively interposed among said output and intermediate shafts and said second motor/generator.

33. The multiple electric motor/generator drive system for vehicular propulsion according to claim 25, wherein said heat engine is selectively engageable to work in parallel with said first and second electric motor/generators at multiple selectable gear ratios.

34. The multiple electric motor/generator drive system for vehicular propulsion according to claim 33, wherein said first and second motor/generators may be simultaneously engaged for maximum power.

35. The multiple electric motor/generator drive system for vehicular propulsion according to claim 34, wherein said first and second motor/generators can be selectively disengaged, allowing said heat engine alone to efficiently power said vehicle.
